(19) United States
(12) Patent Application Publication
(10) Pub. No.: US 2005/0093516 A1
(43) Pub. Date: May 5, 2005

(54) Method and apparatus for measuring electrical cell voltage

(75) Inventor: Jon Beasley, Dearborn, MI (US)

Correspondence Address: TUNG & ASSOCIATES, 838 WEST LONG LAKE, SUITE 120, BLOOMFIELD HILLS, MI, 48302, US

(73) Assignee: Ford Global Technologies, LLC

(21) Appl. No.: 10/700,700

(22) Filed: Nov. 4, 2003

(51) Int. Cl. H02J 7/00

(52) U.S. Cl. 320/134

(57) ABSTRACT

The voltage of each of a plurality of energy providing cells such, as battery or fuel cells, is measured using simple analog components. A comparator circuit connected to each cell compares the cell voltage with a varying reference voltage produced by a voltage ramp generator, and produces a digital output signal when the cell voltage is in a prescribed relationship to the reference voltage. A monitoring circuit receives the digital signals from the comparators and determines the cell voltage based on the value of the reference voltage at the point in time when the digital signal in generated.

### FIELD OF THE INVENTION

The present invention broadly relates to techniques for monitoring the condition of electrical energy cells, such as battery cells or fuel cells, and deals more particularly with a method and apparatus for measuring the voltage output of the cell using simple analog circuit techniques.

### BACKGROUND OF THE INVENTION

Energy providing systems which employ cells or modules to provide electrical energy, such as batteries and fuel cell stacks often employ sophisticated systems for monitoring the condition of individual cells. The condition and readiness of individual cells must be frequently monitored in many applications to ensure that the requisite amount of energy is available on demand. Accordingly, past monitoring systems have included sophisticated circuitry, typically employing analog-to-digital circuit components and processes to measure the voltage in each cell, and determine whether further action is required, such as recharging or switching the cell out of the circuit, depending upon cell condition.

Digital processing techniques, while effective, are more expensive and can be more complex compared to systems that use simple analog techniques. The cost and complexity of digitally based monitoring circuits is multiplied in some applications, such as hybrid fuel systems for vehicles, which rely on multiple fuel cell modules and multi-cell battery packs to supply energy in support of mission critical functions.

It would therefore be desirable to provide a system for measuring the voltage of electrical energy cells or modules using simple analog components and techniques which reduce the complexity and cost of the monitoring circuitry. The present invention is directed toward satisfying this need in the art.

### SUMMARY OF THE INVENTION

According to one aspect of the invention, apparatus is provided for measuring the voltage of each of plurality of cells providing electrical energy. The apparatus includes a reference voltage source for supplying a plurality of differing reference voltages, a plurality of comparator circuits respectively associated with the cells, and a monitoring circuit for receiving and monitoring the signal output by the comparator circuit. The differing reference voltages are produced by a ramp voltage generator that generates a varying voltage signal which serves to provide a plurality of reference values against which the voltage of each cell is compared by the comparator circuit. When the value of the ramp reference voltage is in a prescribed relationship to the cell voltage, the comparator circuit outputs a simple digital signal to the monitoring circuit. Based on the timing of the comparator circuit output, the monitoring circuit associates the digital signal with a measured voltage for the cell.

The comparator circuit preferably includes two analog comparators coupled between the cell and the monitoring circuit. The ramp voltage producing the reference signals is simultaneously applied to all of the comparator circuits respectively associated with the cells being monitored.

According to another aspect of the invention, a method is provided for measuring voltage output by one or more cells providing electrical energy which includes generating a varying voltage reference signal; comparing the voltage of the cell with the varying reference signal; and, generating a digital signal indicative of the measured cell voltage based on the results of the voltage comparison. The varying reference signal is preferably produced using a ramp voltage generator. The voltage comparison is performed using an analog comparator circuit which generates the digital signal indicative of the measured voltage, depending upon the results of the signal comparison.

One of the primary features of the invention is that the electrical condition of a plurality of cells can be monitored using simple, low cost analog techniques. A related advantage is that by using simple analog processing techniques, system reliability can be improved in some cases compared, to more complex digital processing techniques.

Another advantage of the invention is that the voltage measuring system can be implemented using commonly available components.

These, and further features and advantages of the invention will be made clear or will become apparent during the course of the following description of a preferred embodiment of the invention.

### BRIEF DESCRIPTION OF THE DRAWINGS

FIG. 1 is a block diagram of apparatus for measuring the voltage of electrical energy cells forming the preferred embodiment of the invention; and,

FIG. 2 is a detailed schematic diagram showing the cells and the comparator circuits depicted in FIG. 1.

### DETAILED DESCRIPTION OF THE PREFERRED EMBODIMENT

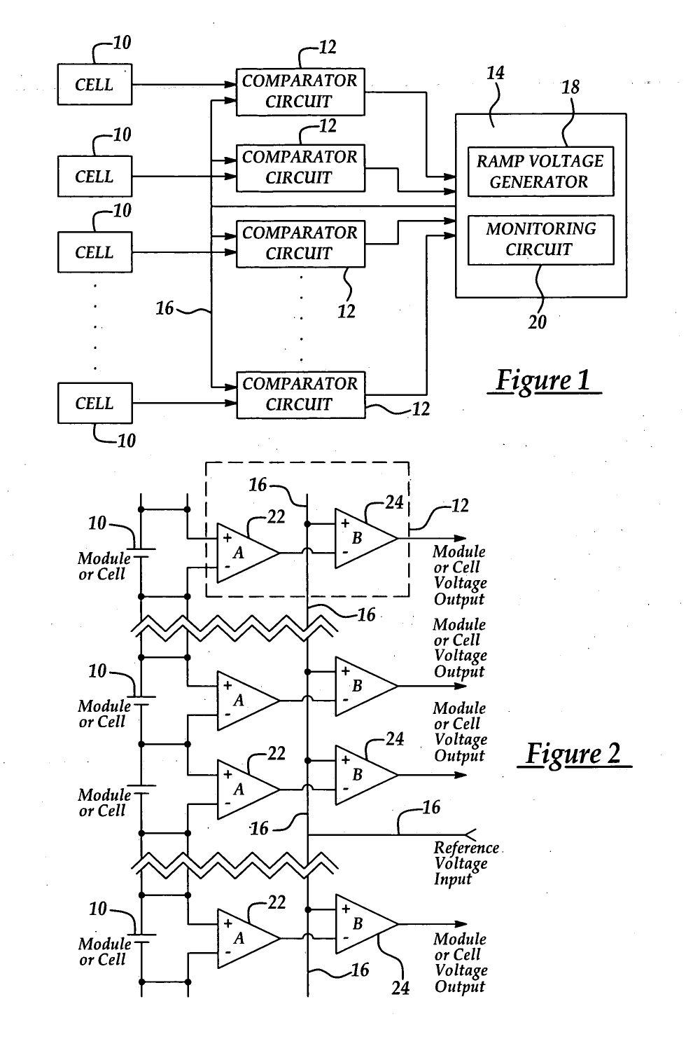

Referring first to FIG. 1, the present invention involves a method and apparatus for monitoring the voltage stored in or output by each of a plurality of individual cells 10 used to produce or store electrical energy. As used herein the term “cell” means any device or structure which stores, produces or generates electrical energy such as, by way of example, a battery cell, a fuel cell or any combination of cells that provide electrical energy and have an output voltage that can be measured. The cells 10 may or may not be interconnected with each other, but typically form a system such as a battery pack, battery module or fuel cell stack. While the invention is disclosed in connection with the measurement of a plurality of the cells 10, it is to be understood that the invention can also be advantageously used to measure the voltage of a single cell 10.

The inventive apparatus includes a plurality of comparator circuits 12 respectively associated with and connected to the cells 10, as well as a controller 14 which includes a ramp voltage generator 18 and a monitoring circuit 20. The controller 14 receives signals from each of the comparator circuits 12, and delivers a signal to the inputs of each of the comparator circuits 12. Specifically, the ramp voltage generator 18 produces a ramp voltage signal that is delivered on line 16 to one input of each of the comparator circuits 12, the other input thereto being formed by a connection to one of the corresponding cells 10. The outputs of each of the comparator circuits 12 is received and monitored by the monitoring circuit 20.

Each of the comparator circuits 12 continuously compares the voltage at its input which is received from the corresponding cell 10, to a reference voltage on a second input of the comparative circuit 12 defined by the vamp voltage signal on line 16. The voltage produced by either the ramp voltage generator 18 or the cell 10 may be either positive or negative in sign. When the voltage of the cell 10 is in a prescribed relationship to the reference voltage, e.g. either equal to or greater than or equal to or less than the reference voltage, the corresponding comparator circuit 12 outputs a digital signal (either a one or a zero) to the controller 14 which is received by the monitoring circuit 20. Based on the value of the reference signal at the time the comparator circuit 12 outputs a digital signal, the monitoring circuit 14 determines the value of the voltage of the corresponding cell 10.

Referring now also to FIG. 2 each of the comparator circuits 12 includes a pair of operational amplifiers 24, 22, each functioning as a comparator and having a pair of inputs and an output. Comparator 22 is configured as a differential operational amplifier having its inputs coupled across the outputs of the corresponding cell 10 so that its output is a signal corresponding to the voltage of the associated cell 10. The output of comparator 22 is delivered to one input of comparator 24, the second input thereof being connected by line 16 to the ramp voltage generator 18. Each of the comparators 24 functions to compare the voltage value output by the associated comparator 22 with the instantaneous value of the ramp voltage present at its other input, and delivers a digital signal (one or zero) at its output when the values on its inputs are in a prescribed relationship. For example, each of the comparators 24 may be set so as to produce an output signal when the cell voltage output by comparator 22 is either greater than or less than a certain value, or within a prescribed range of values of the varying ramp voltage. In effect, because the reference signal applied to the comparators 24 is a varying ramp voltage, the comparators 24 compare the cell voltage to each of a plurality of reference voltages.

The ramp voltage generator 18 may include any of various circuits well known in the art for producing a voltage whose magnitude varies with time, although it is disclosed herein as being a ramp. The details of the monitoring circuit 20 will vary with the particular application, however it can be formed using conventional components and signal processing techniques. The monitoring circuit includes provisions for associating the timing of the receipt of a digital output signal from each of the comparator circuits 12 with the value of the ramp voltage at that point in time, and make a determination whether the cell voltage is either above, below or within a range of acceptable values. The monitoring circuit 20 may optionally form part of an electronic control circuit which functions to individually disconnect or reconnect the cells 10 with each other or with a load so as to manage system output.

From the foregoing, it may be appreciated that the method and apparatus for measuring cell voltage as described above provides for a particularly simple and economical solution to the problem of measuring cell voltage. It is recognized, of course, that those skilled in the art may make various modifications or additions to the preferred embodiment chosen to illustrate the invention without departing from the spirit and scope of the present contribution to the art. Accordingly, it is to be understood that the protection sought and to be afforded hereby should be deemed to extend to the subject matter claimed and all equivalents thereof fairly within the scope of the invention.

1. Apparatus for measuring the voltage of a cell providing electrical energy, comprising:
a reference voltage source for supplying a plurality of differing reference voltages;
a first comparator having first and second inputs, and an output, the first input being connected to receive the voltage of the cell, the second input being connected to receive the reference voltages, the comparator being operable to compare the cell voltage on the first input with each of the reference voltages on the second input and producing a signal on the output when the cell voltage is in a prescribed relationship to one of the reference voltages; and
a monitoring circuit for receiving and monitoring the output signal signal.

2. The apparatus as set forth in claim 1, wherein the output signal is a digital signal

3. The apparatus as set forth in claim 2, wherein the reference voltage source includes a ramp voltage generator for producing a ramp voltage which includes the plurality of reference voltages.

4. The apparatus as set forth in claim 2, including a second comparator having first and second inputs connected across the cell, and having an output for delivering the cell voltage to the first input of the first comparator.

5. The apparatus as set forth in claim 2, including a second, differential comparator connected between the cell and the first comparator, the differential comparator being operative to deliver the cell voltage to the first input of the first comparator.

6. Apparatus for measuring the voltage of each of a plurality of cells providing electrical energy, comprising:
a reference voltage source for supplying a plurality of differing reference voltages;
a plurality of comparator circuits respectively associated with the cells and each connected to receive the voltage provided by a corresponding cell, each of the comparator circuits being operative to compare the cell voltage with the reference voltages and for producing an output signal when the cell voltage is in a prescribed relationship to one of the reference voltages; and
a monitoring circuit for receiving and monitoring the signals output by each of the comparators.

7. The apparatus as set forth in claim 6, wherein the signal output by each of the comparators is a digital signal.

8. The apparatus as set forth in claim 6, wherein the comparator circuit includes:
a first comparator having first and second inputs and having an output for delivering the output signal to the monitor; and,
a second comparator connected between the corresponding cell and the first comparator.

9. The apparatus as set forth in claim 8, wherein the second comparator includes first and second inputs connected across the cell to receive the cell voltage, and an output connected to the first input of the first comparator.

10. The apparatus as set forth in claim 9, wherein the second input of the first comparator is connected to the reference voltage source.

11. The apparatus as set forth in claim 8, wherein the signal output by each of the first comparators is a digital signal.

12. The apparatus as set forth in claim 6, wherein the reference voltage source includes a ramp voltage generator for generating a varying ramp voltage which includes each of the reference voltages.

13. The apparatus as set forth in claim 12, wherein the signal output by each of the comparator circuits is a digital signal.

14. A method for measuring the voltage output by each of a plurality of cells providing electrical energy, comprising the steps of:
(A) generating a plurality of differing reference voltages;
(B) comparing the voltage of each of the cells with each of the reference voltages;
(C) generating a signal indicative of the measured voltage for each cell based on the results of the comparison performed in step (B).

15. The method as set forth in claim 14, wherein step (A) includes producing a ramp voltage which includes each of the reference voltages.

16. The method as set forth in claim 15, wherein step (B) is performed by comparing each of the cell voltages to the ramp voltage.

17. The method as set forth in claim 14, wherein step (B) is performed using a comparator circuit.

18. The method as set forth in claim 14, wherein step (C) includes producing a digital signal when the cell voltage compared in step (B) is in a prescribed relationship to one of the reference voltages.

19. A method for measuring the voltage output by at least one cell providing electrical energy, comprising the steps of:
(A) generating a varying voltage reference signal;
(B) comparing the voltage of the cell with the varying reference signal generated in step (A);
(C) generating a digital signal indicative of the measured voltage for the cell based on the results of the comparison performed in step (B).

20. The method as set forth in claim 19, wherein step (A) is performed using a ramp voltage signal generator.

21. The method as set forth in claim 19, wherein step (B) is performed using a comparator circuit.

22. The method as set forth in claim 21, wherein step (C) is performed using a signal output by the comparator circuit.
